(19) United States
(12) Patent Application Publication
(10) Pub. No.: US 2006/0005461 A1
(43) Pub. Date: Jan. 12, 2006

(54) Rodent trap assembly with windowed enclosure

(76) Inventor: James Schimes Vieira, Scranton, PA (US)

Correspondence Address: Anita Lomartra;McCARTER & ENGLISH, LLP, CityPlace I, 185 Asylum Street, Hartford, CT, 06103, US

(21) Appl. No.: 11/118,446

(22) Filed: Apr. 29, 2005

Related U.S. Application Data
(60) Provisional application No. 60/566,660, filed on Apr. 30, 2004.

(51) Int. Cl. A01M 23/30

(52) U.S. Cl. 43/81

(57) ABSTRACT

A rodent trap assembly is provided that includes: (i) an enclosure defining at least one outer wall and an enclosed region; (ii) a trap positioned within the enclosed region; and (iii) a viewing window formed in the at least one outer wall. The viewing window is advantageously sized and positioned relative to the trap such that the condition of the trap may be determined by viewing of the trap through the viewing window. The disclosed assembly provides a safe, sanitary way to catch rodents (and other small animals), while eliminating the need to handle dead and potentially contaminated rodents/animals. The unsightly aspects of dealing with trapped rodents/animals are largely eliminated by positioning the trap mechanism within an enclosure. Disposal of the trapped rodent is facilitated through simple closure of the bag/container with the trapped rodent/animal therewithin.

### CROSS-REFERENCE TO RELATED APPLICATIONS

The present application claims the benefit of a co-pending provisional patent application entitled “Rodent Trap Assembly with Windowed Enclosure,” which was filed on Apr. 30, 2004 and assigned Ser. No. 60/566,660. The entire contents of the foregoing provisional patent application are incorporated herein by reference.

### BACKGROUND OF THE DISCLOSURE

1. Technical Field

The present disclosure is directed to a rodent trap with a windowed enclosure and, more particularly, the present disclosure is directed to a rodent trap that is positioned within an enclosure that includes at least one viewing window, such viewing window being sized and configured such that the condition of the rodent trap may be determined by viewing therethrough.

2. Background Art

Efforts have been expended over the years aimed at developing advantageous rodent traps. In some instances, these efforts have yielded a rodent trap positioned within an enclosure. For example, U.S. Pat. No. 3,992,803 to Kaiser discloses a mouse trap wherein the trap is positioned within a housing that is open at one end and wherein the trap mechanism is mounted to a back closure wall of the housing. According to the Kaiser '802 patent, the enclosure is disposable or capable of having a killed animal displaced therefrom without personal contact therewith.

U.S. Pat. No. 4,030,230 to Souza discloses an animal trap and package therefor, wherein the trap is normally urged into a collapsible container forming part of the package, such as a paper bag, by a resilient means. The resilient means generally takes the form of a rubber band and a limited stop means is provided that temporarily maintains the trap outside the container. When the animal triggers the trap, the impact causes the trap to jump the stop and be withdrawn into the container. Thereafter, the trap and the trapped animal are encased in the container and can be disposed of without contact by the user.

U.S. Pat. No. 4,403,438 to West-Harron discloses a disposable rodent trap that is adapted to be pre-set and pre-baited during manufacture, placed in an appropriate housing and discarded after use. The trap consists of an essentially traditional spring biased killing jaw with a retaining cord that holds the jaw in a loaded position and is disposed to release the jaw when the cord is severed, i.e., through the chewing of a rodent. Other prior art efforts are disclosed in U.S. Pat. Nos. 4,825,579 to Dzurkovich et al., U.S. Pat. No. 5,706,601 to Dail, and U.S. Pat. No. 6,266,917 to Hight.

Despite efforts to date, a need remains for a rodent trapping system that is easy to use, avoids the need for a user to handle the dead animal, and permits the user to easily and effectively monitor the condition of the trapping system. These and other objects/needs are advantageously addressed by way of the rodent trap assembly disclosed herein.

### SUMMARY OF THE DISCLOSURE

The present disclosure provides advantageous rodent trap assemblies. According to exemplary embodiments of the present disclosure, a rodent trap assembly is provided that includes: (i) an enclosure defining at least one outer wall and an enclosed region; (ii) a trap positioned within the enclosed region; and (iii) a viewing window formed in the at least one outer wall. The viewing window is advantageously sized and positioned relative to the trap such that the condition of the trap may be determined by viewing of the trap through the viewing window. In further exemplary embodiments of the disclosed rodent trap assembly, the enclosure may take the form of a bag. In addition, the base of the trap may be advantageously adhered to the enclosure.

The viewing window offers a trap user the ability to monitor the status of the trap. In exemplary embodiments, the viewing window is substantially square in geometry. The geometric design of the enclosure may vary, although in exemplary embodiments, the enclosure defines a top wall, a bottom wall, two side walls and a front face. An opening is typically defined opposite the front face and the viewing window is positioned in the top wall. The viewing window and top wall are generally dimensioned such that the viewing window forms approximately 20% to about 40% of the surface area of the top wall.

Rodent trap assemblies according to the present disclosure may be fabricated such that the enclosure is of multi-layered construction. In such multi-layered construction, one layer is typically a transparent or translucent plastic film. The viewing window may thus be defined by exposing the transparent/translucent plastic film to a desired degree and in a desired location. A further layer of the multi-layered construction may take the form of a foil layer, while a still further layer may be a paper stock layer.

Additional features, structures and attributes of the disclosed rodent trap assembly will be apparent from the detailed description which follows, particularly when viewed in connection with the figures appended hereto.

### BRIEF DESCRIPTION OF THE FIGURES

To assist those of ordinary skill in the art in making and using the disclosed rodent trap assemblies, reference is made to the accompanying figures, wherein:

FIG. 1 is a top view of an exemplary rodent trap assembly according to the present disclosure;

FIG. 2 is an end view of the exemplary rodent trap assembly of FIG. 1; and

FIG. 3 is side view of the exemplary rodent trap assembly of FIGS. 1 and 2.

### DETAILED DESCRIPTION OF EXEMPLARY EMBODIMENT(S)

According to the present disclosure, advantageous rodent trap assemblies are provided that offer a safe and sanitary way of catching rodents. The disclosed rodent trap assemblies eliminate the need for users to handle dead and potentially contaminated/diseased rodents. Moreover, the disclosed rodent trap assemblies are easily manufactured and used, permit simple and rapid disposal after successful trapping of a rodent, and limit the unsightly mess generally associated with rodent traps. These and other features, functions and advantages are readily apparent from the detailed description which follows.

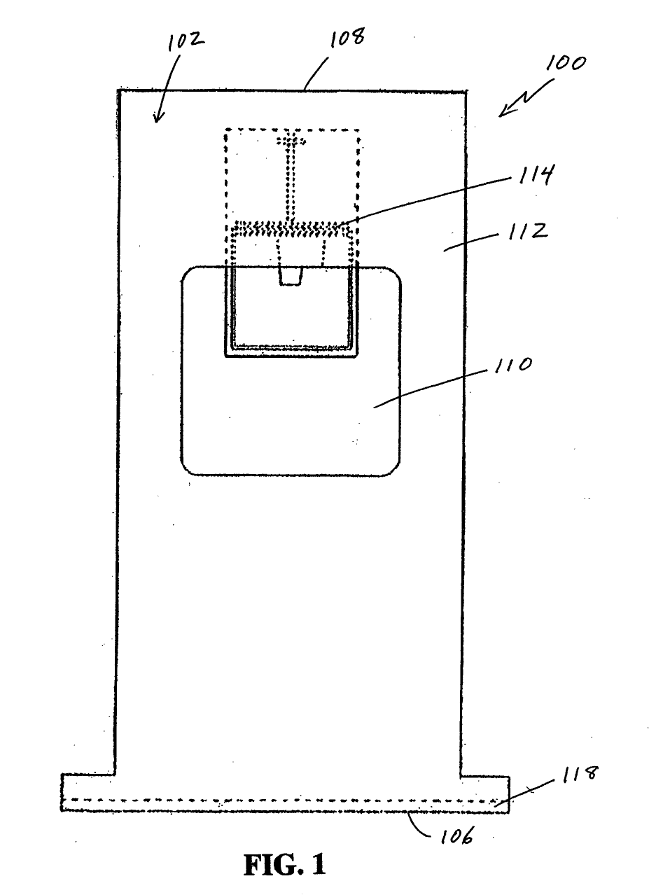

With reference to FIG. 1, a top view of an exemplary rodent trap assembly 100 is schematically depicted. The exemplary assembly 100 includes an outer container 102 or, in this exemplary embodiment, bag 102, that defines an inner region or cavity 104 (best seen in FIG. 2). In the schematically depicted exemplary embodiment, the bag 102 defines an elongated axis that extends from an opening 106 (at the lower end of the schematic view) and an enclosed end 108 (at the top of the schematic view). In the depicted embodiment, the length of the bag is approximately 9.75″ and the width of the bag is approximately 4.75″. These dimensions correspond to the dimensions of typical “air sickness” bags found on commercial airlines. Alternative dimensions may be employed according to the present disclosure, as will be readily apparent to persons skilled in the art, provided an inner region/cavity of sufficient size for positioning and operation of a rodent trap is provided.

With further reference to the top view of FIG. 1, a window or transparent/translucent region 110 is defined in the upper wall 112 of the bag 102. The window region 110 may assume a variety of geometric shapes, e.g., rectangular, square, circular, trapezoidal, triangular, etc. In the disclosed embodiment, the window region 110 is approximately 3″×3″ and is centrally positioned from a side-to-side standpoint, i.e., relative to the width of the bag 102. However, the window region 110 is generally positioned/defined closer to the closed end 108 of the bag, as opposed to the open end 106 of the bag 102. The overall positioning of the window region 110 is typically selected so as to ensure a desired level of viewing into the inner region or cavity 104 such that the condition and/or operation of the rodent trap 114 may be determined by viewing therethrough. Thus, the window region 110 provides an advantageous “sight window” that permits a user to monitor the status of the rodent trap 114, while protecting against (and eliminating the necessity for) direct contact with the trap and/or the trapped rodent.

In the depicted exemplary embodiment, a rodent trap 114 is positioned toward the closed end 108 of the bag, with the trap jaw positioned closest to the closed end 108 prior to triggering. In this way, a rodent that ventures into the bag 102 will be fully ensconced within the bag 102 at such time as it triggers the trap 114 and is captured thereby. The trap 114 may be advantageously adhered to the bottom wall 116 of the bag 102, e.g., with a conventional adhesive, two-sided tape or the like. The disclosed rodent trap assembly 100 is suitable for use with a wide variety of rodent trap mechanisms 114, e.g., spring-loaded trap mechanisms.

With particular reference to the window region 110 formed/defined in the container/bag 102, such window region 110 is typically defined by a transparent/translucent plastic material, e.g., a relatively thin film material. The window region 110 may be mounted with respect to the bag wall such that it completely seals the opening defined in the upper wall of the bag/container. In such embodiment, the plastic window material may be adhered to the inner or outer surface of the bag's upper wall, e.g., with a conventional adhesive, and typically overlaps the upper wall surface for a limited distance around the circumference of the opening, thereby ensuring adequate adherence therebetween. In an alternative embodiment, the transparent/translucent plastic film constitutes an inner layer of the bag/container such that exposure thereof may be accomplished by “cutting away,” i.e., removing, a desired portion of the bag material (e.g., appropriate paper stock) to define/form the window region 110. In this latter embodiment, the transparent/translucent plastic film is typically adhered to the outer paper stock, thereby defining at least a two-layer container/bag structure. The window region 110 typically defines approximately 20% to about 40% of the surface area of the top wall of the bag/container 102. The bag/container 102 also typically defines a “foil layer” which may replace or augment the paper stock layer discussed above.

A closure mechanism 118 is typically provided at the open end 106 of the bag/container 102, e.g., a stiffening wire in combination with outwardly extending closure tabs. The closure mechanism 118 may be integrally formed with the bag/container 102, or may be fabricated as a separate component and mounted/adhered to the bag/container surface, as is known in the art. The closure mechanism 118 advantageously facilitates sanitary closure of the bag/container 102, e.g., with a trapped rodent therewithin. The closure mechanism 118 is typically mounted (or formed) with respect to the upper wall of the bag/container 102, thereby facilitating access and use thereof when a rodent is positioned in the inner region/cavity 104.

With reference to FIG. 2, a front view of an exemplary rodent assembly 100 according to the present disclosure (looking into the inner region/cavity 104 through the open end 108) is provided. As shown therein, a rodent trap 114 is positioned on the bottom wall of the exemplary bag/container, and the inner region/cavity 104 is further defined by a pair of side walls and a rear wall. Closure end tabs project beyond the side walls at the top surface of the bag/container. Slight folding creases that are typically defined in the side walls of the bag/container are identified in this schematic front view.

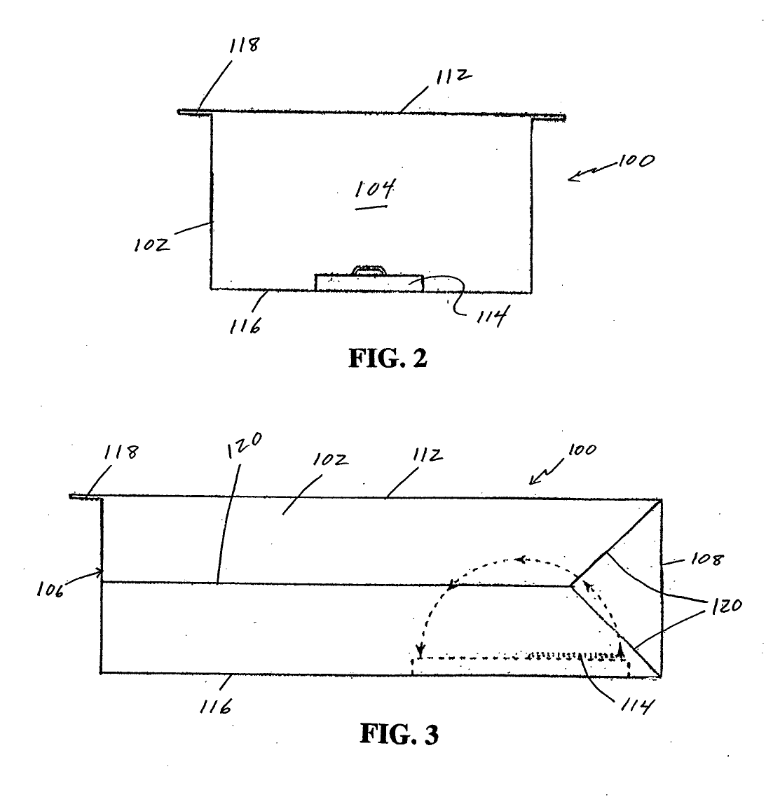

Turning to FIG. 3, a side view of the exemplary rodent assembly 100 is provided, with a rodent trap 114 positioned therewithin shown in phantom. As shown in this side view, the rodent trap 114 is typically positioned in relatively close juxtaposition relative to the rear wall of the bag/container. The “height” of the bag/container (which is defined by the dimensions of the side walls) is selected so as to ensure free movement/operation of the rodent trap 114 positioned therewithin (as evidenced by the phantom arc which represents trap jaw movement, once triggered). In the exemplary embodiment depicted in the schematic view of FIG. 3, the height of the bag/container 102 is approximately 2.5″, although alternative dimensions that permit unimpeded operation of the rodent trap 114 may be employed, as will be readily apparent to persons skilled in the art. The “triangulated lines” shown in the schematic side view represent fold creases 120 that are associated with an exemplary bag 102 according to the present disclosure.

Thus, according to the present disclosure, an advantageous rodent trap assembly with windowed enclosure is provided. The “TRAP-N-A-BAG” product provides a safe, sanitary way to catch rodents (and other small animals), while eliminating the need to handle dead and potentially contaminated rodents/animals (potential contamination issues include hantavirus, salmonellosis and other potentially communicable diseases to humans and/or pets). The unsightly aspects of dealing with trapped rodents/animals are largely eliminated by positioning the trap mechanism within an enclosure. Disposal of the trapped rodent is facilitated through simple closure of the bag/container with the trapped rodent/animal there within.

In use, a user initially baits and sets the trap that is positioned within the bag/container. The trap is positioned such that it may be viewed through the window region, i.e., the “sight window.” As noted previously, the trap is typically adhered (or may be adhered by the user) to the bottom wall of the bag/container, e.g., using double-sided tape or the like. The window region allows a user to monitor the status/condition of the trap. Once the trap has been triggered so as to capture a rodent/animal, the bag/container is typically closed with the trap/rodent therewithin, e.g., using a closure mechanism associated with the bag/container (e.g., closure taps positioned adjacent the open end of the bag/container). The bag/container helps to contain any odors associated with the rodent/animal and obviates the need for a user to come into contact with the rodent/animal or any blood/debris associated with its capture. The closed bag/container keeps odors from other animals and the walls of the bag/container, e.g., the foil lining thereof, prevent seepage of fluids associated with the rodent/animal from the bag/container.

Additional features, functions and advantages associated with the rodent trap assembly of the present disclosure will be readily apparent from the description provided herein. Thus, the present disclosure is not limited to the exemplary embodiments described herein, but encompasses improvements, modifications and/or enhancements that will be apparent from the detailed description provided herein.

1. A rodent trap assembly, comprising:
a. an enclosure defining at least one outer wall and an enclosed region;
b. a trap positioned within said enclosed region;
c. a viewing window formed in said at least one outer wall;
wherein said viewing window is sized and positioned relative to said trap such that the condition of said trap may be determined by viewing of said trap through said viewing window.

2. A rodent trap assembly according to claim 1, wherein said enclosure is a bag.

3. A rodent trap assembly according to claim 1, wherein a base of said trap is adhered to said enclosure.

4. A rodent trap assembly according to claim 1, wherein said viewing window is substantially square in geometry.

5. A rodent trap assembly according to claim 1, wherein said enclosure defines a top wall, a bottom wall, two side walls and a front face, and wherein an opening is defined opposite said front face.

6. A rodent trap assembly according to claim 5, wherein said viewing window is positioned in said top wall.

7. A rodent trap assembly according to claim 6, wherein said viewing window and top wall are dimensioned such that the viewing window forms approximately 20% to about 40% of the surface area of the top wall.

8. A rodent trap assembly according to claim 1, wherein the enclosure is of multi-layered construction, and wherein one layer of such multi-layered construction is a transparent/translucent plastic film.

9. A rodent trap assembly according to claim 8, wherein said viewing window is defined by exposing said transparent/translucent plastic film to a desired degree and in a desired location.

10. A rodent trap assembly according to claim 1, wherein the enclosure is of multi-layered construction, and wherein one layer of such multi-layered construction is a foil layer.

11. A rodent trap assembly according to claim 1, wherein the enclosure is of multi-layered construction, and wherein one layer of such multi-layered construction is a paper stock layer.
